(19) United States
(12) Patent Application Publication
(10) Pub. No.: US 2017/0150425 A1
(43) Pub. Date: May 25, 2017

(54) SYSTEM, FOR A MOBILE TERMINAL, FOR ASSISTING IN THE SELECTION OF A RADIO COMMUNICATION INFRASTRUCTURE; ASSOCIATED ASSEMBLY AND METHOD

(71) Applicant: CENTRE NATIONAL D'ETUDES SPATIALES, Paris (FR)

(72) Inventor: Jacques BEAS-GARCIA, TOULOUSE (FR)

(21) Appl. No.: 15/309,637

(22) PCT Filed: May 13, 2015
(86) PCT No.: PCT/EP2015/060705

§ 371 Date: Nov. 8, 2016

(30) Foreign Application Priority Data
May 15, 2014 (FR) 14 54353

(51) Int. Cl. H04W 48/16; H04W 64/00; H04W 76/02; H04W 48/18

(52) U.S. Cl. CPC H04W 48/16; H04W 48/18; H04W 64/00; H04W 76/02; H04W 88/06

(57) ABSTRACT

This system includes: —a database including maps, each map being associated with an infrastructure from a plurality of available infrastructures and providing, at each point of a geographical zone, a local value of a property relative to a quality of experience associated with the execution of an application accessing a remote resource through the infrastructure; a localization element generating a current position of the mobile terminal; a selection element for selecting a trajectory; a correlation element able, from the current position, the selected trajectory, and each map, to determine a correlation coefficient; and a selection unit able, based on the correlation coefficients, to select an infrastructure from among the plurality of infrastructures.

The invention relates to the field of systems, for a mobile terminal, for assisting in the selection of a radio communication infrastructure from among a plurality of available radio communication infrastructures, so that an application run on the mobile terminal can communicate with a separate resource and give its user a satisfactory quality experience.

In the present document, the term “mobile terminal” refers to any type of portable communication equipment, for example a telephone, smart phone, tablet or the like.

Certain software applications, when they are executed on a mobile terminal, must exchange data with a remote system, via a communication network accessed by the mobile terminal via a radio communication infrastructure.

A radio communication infrastructure includes a plurality of fixed access points. Each access point has a radio electric range, defining a coverage cell around its antenna. The different cells of the access points of a same infrastructure together define the coverage of the infrastructure.

A radio communication infrastructure implements a specific communication protocol, which allows the establishment of a link between a mobile terminal and one of its access points, then the maintenance of that link and the communication of data on that link.

Many communication protocols are known by those skilled in the art, for example the 3G, LTE, WiFi, Wi-MAX, Bluetooth protocols or the like. A protocol refers to the smallest granularity of a protocol, going as far as the groups of versions compatible with one another. Thus, the WiFi protocol is subdivided into WiFi-b, WiFi-G, WiFi-n, etc. protocols.

The communication protocol implemented by an infrastructure defines the type of that infrastructure.

In order to establish, maintain and use a link with an infrastructure of a particular type, the mobile terminal is provided with a radio wave transceiver module suitable for the protocol implemented by said infrastructure.

Today, a mobile terminal includes a plurality of transceiver modules, each module being associated with a particular protocol and consequently a type of infrastructure.

Thus, at a given moment, several infrastructures are generally available to allow the mobile terminal to establish a link allowing it to access the network. This then involves choosing an infrastructure from among the set of available communication infrastructures.

It is known that a mobile terminal is capable of discovering all of the available infrastructures located in its vicinity. For example, the mobile terminal is able to successively command each of its transceiver modules to scan its working frequency band, looking for beacon signals transmitted by the access points of an infrastructure. Based on the detected beacon signals, a mobile terminal establishes a list of available infrastructures from its location. The mobile terminal next selects an infrastructure from the obtained list, for example the infrastructure whose beacons are most powerful.

It is also known, for example from document US 2012/0196644, that a user of a mobile terminal may query a server storing a map indicating, for each point of a geographical region, a list of infrastructures accessible from that point, as well as, for each infrastructure accessible from that list, information about the quality of service that may be expected from a link established from that point with that infrastructure. Based on the current point where the mobile terminal is located, the latter determines the list of available infrastructures and selects the infrastructure having the best expected quality of service.

These solutions of the state of the art are intended for a static mobile terminal, i.e., substantially immobile at a point and that has the necessary time either to discover its wireless environment itself, or to query a server including a map of the wireless environment, then to determine a list of accessible infrastructures, before selecting one and connecting to it.

However, if the mobile terminal moves, the process of establishing a list of available infrastructures must be executed periodically at each new location point of the mobile terminal.

For example, regarding the discovery process, if the mobile terminal has established a first link with an access point of an infrastructure, when this first link is broken or about to be broken, the mobile terminal once again carries out the discovery process. It begins with the transceiver module used to establish the first link in order to detect another access point of the same infrastructure and thus quickly establish a second link with that same infrastructure and switch the communication in progress as quickly as possible. If the establishment of such a second link fails, the discovery process is extended to the other transceiver modules of the mobile terminal in order to discover other infrastructures allowing the communication in progress to continue.

Such a method has a risk of leading to frequent switches from one infrastructure to another, which is detrimental to the quality of service of the communication in progress.

Aside from the practical difficulties of discovering the environment, choosing an infrastructure, then ultimately establishing a connection, these steps are greedy in terms of electricity consumption. When these steps, which are not part of the communication of data to run the application executed by the mobile terminal, must be carried out upon each new relatively stable position of the mobile terminal, the autonomy of the latter is greatly penalized.

Furthermore, the mobile terminal must stay in one place long enough to discover its environment, choose an infrastructure and establish a link before any communication. If the mobile terminal moves too quickly relative to the dimensions of the cells of an infrastructure, the application will not have time to exchange data with the remote server. This is for example the case for a mobile terminal placed in a car traveling in a zone nevertheless situated within the coverage of a Wi-Fi infrastructure. Although the access points of this infrastructure are visible and accessible, the mobile terminal does not stay long enough in the cell associated with each access point of the infrastructure to establish a link allowing the application to communicate with the remote server.

Lastly, the mobile terminal is able to execute software instructions of different types, depending on the format of the data exchanged with the remote server: A first type for example consists of applications making it possible to view a webpage using the HTTP format. A second type for example consists of applications making it possible to view a streaming video on the mobile terminal. A third type for example consists of applications making it possible to download, on the mobile terminal, a large file using the FTP format, etc.

Yet certain types of infrastructure are more suitable than others for the communication of certain data formats, and consequently better suited than others to executing a type of application.

It is therefore necessary to account for the specificities of the available infrastructures based on the type of application executed in order to provide the user of the mobile terminal with the best possible quality of experience.

The quality of experience refers in this document not only to the quality of service of the link between the input/output module of the mobile terminal and the access point of the infrastructure to which it is connected, but more generally all of the parameters that may affect the user's perception of the execution of the application.

Thus, the quality of experience here is associated not only with the lowest layers of the OSI model, which relate to the communication protocol of the link, but also to the highest layers of the OSI model, which relate to the format of the data exchanged by the application.

This is for example the case for a satellite infrastructure that proposes very interesting throughputs, but with a greater latency than the traditional infrastructures. A satellite infrastructure will thus be better suited to transferring large data, while a 3G infrastructure, offering a slower connection but with a lower latency, will be better suited to periodic viewing of a webpage, for example to update a weather application.

The invention therefore aims to resolve the aforementioned problems.

The invention in particular aims to offer a system allowing the selection, from among the available infrastructures, of the best infrastructure in terms of quality of experience in light of the movement of the mobile terminal along a trajectory.

The invention therefore relates to a system, an assembly and a method according to the claims.

The invention takes the trajectory of the user into account in selecting an infrastructure from among several available infrastructures.

In the present document, a position associates a geographical point (defined by three spatial coordinates) and a moment (defined by a time coordinate); a trajectory is a set of successive positions including at least the current position and a future position of the mobile terminal.

Thus, a first infrastructure offering continuous coverage along a trajectory will be given preference over a second infrastructure offering a first portion of the trajectory with a high throughput, but not offering any coverage on a second portion of the trajectory. This second infrastructure, during the passage from the first to the second portion of the trajectory, leads to the interruption of the communication in progress and the application will not be able to run appropriately, which the user will notice immediately.

Taking the user's trajectory into account is even more necessary when the speed of the mobile terminal is high, such that the time that it spends in the cell associated with an access point is reduced. Thus, an infrastructure may offer a satisfactory throughput at a low speed, but have a greatly reduced throughput at a high speed, the majority of the time that the mobile terminal spends in a cell being used to establish the link rather than to communicate data.

The invention and its advantages will be better understood upon reading the following description of several embodiments, provided solely as a non-limiting example, the description being done in reference to the appended drawings, in which:

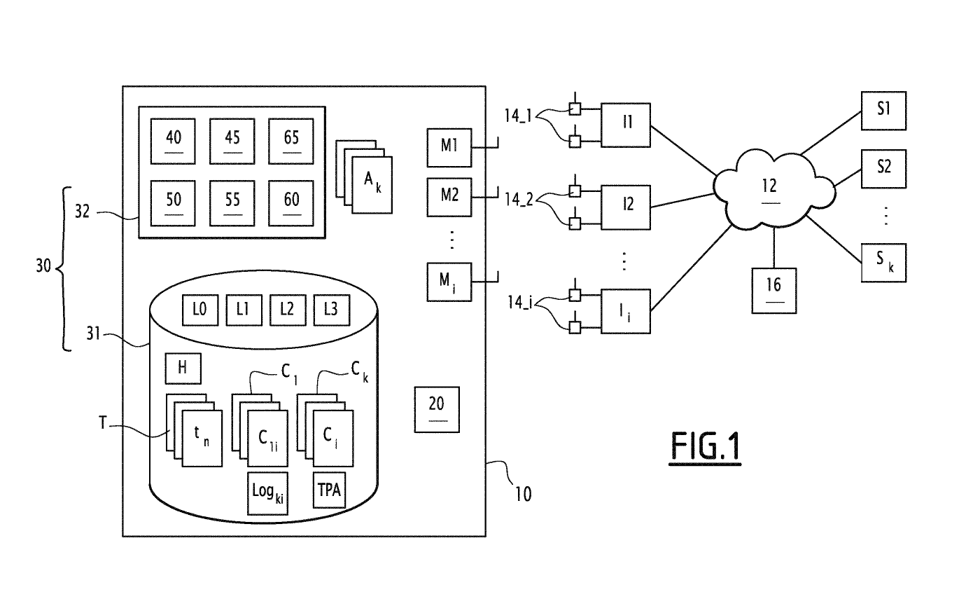

FIG. 1 is a diagrammatic illustration of the system to assist with selecting a radio communication infrastructure according to the invention;

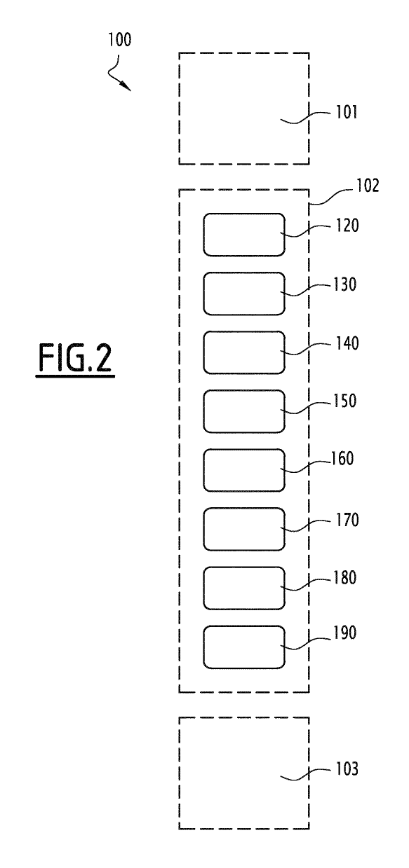

FIG. 2 is a diagrammatic illustration of a first embodiment of the method to assist with selecting a radio communication infrastructure according to the invention; and

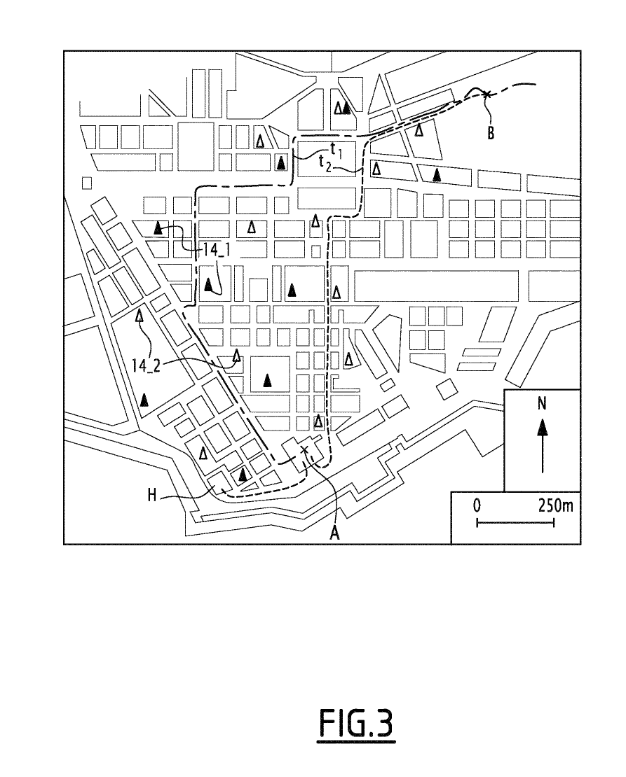

FIG. 3 is a diagrammatic illustration of one particular use of the method of FIG. 2.

The system for assisting in the selection of a radio communication infrastructure is intended to be implemented by a mobile host terminal.

As shown diagrammatically in FIG. 1, the mobile terminal 10 includes a plurality of applications Ak, able to be run on the mobile terminal, optionally at the same time.

During its execution, an application Ak requires the exchange of data with a remote server Sₖ, which is connected to a communication network 12, like the Internet.

An application Aₖ belongs to a particular type. The type of application is characterized by the format of the data exchanges with the server Sₖ. In order to simplify the description, the applications Aₖ are of different types from one another. Alternatively, several applications may be of the same type. These may for example involve an Internet browser, a movement assistance system, a video reading program, etc.

The mobile terminal 10 includes a plurality of transceiver modules Mi. Each transceiver module is associated with a determined communication protocol Pi. Thus, a transceiver module Mi makes it possible to establish and maintain a radio link with a radio communication infrastructure of the type defined by said protocol Pi.

In the geographical zone in which the mobile terminal 10 is called upon to move, different infrastructures Ii are accessible. To simplify the description, each infrastructure Ii corresponds to a protocol Pi and, in the environment of the mobile terminal 10, there is only one infrastructure of each type. Alternatively, several infrastructures may be of the same type.

Each infrastructure Ii has a plurality of access points 14_i. An access point 14_i allows a mobile terminal located in the coverage cell associated with the access point in question to establish a temporary radio communication link with the corresponding infrastructure Ii.

Each infrastructure Ii is also connected to the network 12.

Thus, when the mobile terminal 10 has established a connection with one of the infrastructures through an access point, the application Ak executed on the mobile terminal 10 can access the remote resource on the server Sₖ.

The mobile terminal 10 includes a localization module 20 making it possible to determine, at each moment, a current position of the mobile terminal 10: P(X, Y, Z, t). A position includes three spatial coordinates (X, Y and Z, where the coordinates X and Y give a point on a horizontal reference plane and the coordinate Z gives a height—altitude—relative to the horizontal reference plane) and a time coordinate (t).

Different localization means are known for a piece of equipment.

Preferably, the localization module 20 of the mobile terminal 10 is an improved satellite positioning means. Positioning signals emitted by a constellation of satellites are received by the localization means 20, which, from the signals and correction information for the distortions introduced by the ionosphere and the signals, determines the instantaneous position of the mobile terminal 10 with a precision that may reach approximately a centimeter.

Other localization means are known, such as the A-GPS means, which is a satellite positioning means augmented by a ground component to improve the precision of the positioning. A differential mode also exists, called D-GPS.

The GSM mobile telephone protocol also makes it possible to localize a portable telephone by triangulating signals exchanged between the telephone and a group of access points of the GSM infrastructure.

The previous localization means only work correctly outdoors. Inside a building, the instantaneous position of a mobile terminal may be obtained from a plurality of WiFi access points having a known installation point. For example, the “WiFi fingerprinting” method may be implemented.

The iBeacon localization means is also known in case of a Bluetooth infrastructure, which allows localization in buildings with a precision of approximately one meter.

Advantageously, the localization module 20 also incorporates an inertial unit allowing an estimate of the current position when the latter cannot be measured directly by the satellite means. This is for example the case when the user of the mobile terminal enters a building. The inertial unit makes it possible to estimate the current instantaneous position from the last measured position by incorporating the elementary movements of the mobile terminal.

The mobile terminal 10 includes a system 30 to assist in the selection of an infrastructure, which includes a database 31 and a software program 32.

The database 31 includes a plurality of map tables Cₖ, each map table being associated with a particular application type, i.e., with a particular application Aₖ in the case of the present description.

A map table Cₖ includes a plurality of maps Cₖᵢ, each map being associated with an infrastructure Ii.

A map Cₖᵢ gives, for each point of the geographical zone of interest, the quality of experience associated with the use of the application Aₖ, when the mobile telephone on which it is executed is connected to the infrastructure Iᵢ.

Preferably, a map Cₖᵢ includes a plurality of elementary maps Cₖᵢ(hⱼ), the elementary map Cₖᵢ(hⱼ) giving, for each point of the geographical zone of interest, the quality of experience associated with the use of the application Aₖ, during the time range hⱼ, when the mobile telephone on which it is executed is connected to the infrastructure Iᵢ. The time range hⱼ is a time range within a day, a week, or any other discriminating time interval. Indeed, certain infrastructures, reserved for certain uses and users during the day, are freely accessible at the end of the day. For example, these involve Wi-Fi infrastructures in hospitals, which are accessible to patients at the end of the day so that they can watch TV, check their e-mail, receive telephone calls, these infrastructures being turned off during the day so as not to interfere with the medical equipment.

The database 31 includes a table of trajectories T grouping together a plurality of trajectories tₙ.

In the present document, a trajectory tₙ is made up of a plurality of intermediate positions, between a starting position, at a starting moment, and an arrival position, at an arrival moment. The intermediate positions are for example separated from one another by a sampling period Δt.

In place of or in addition to the table of trajectories T, the database 31 includes a history H of the current [and] past positions of the mobile terminal 10. The history makes it possible to store the current positions delivered by the localization module 20 over a time window D that precedes the current moment t.

The software program 32 of the system 30 includes a module 40 for selecting a trajectory.

The software program 32 of the system 30 includes a reducing module 45, making it possible to reduce the number of infrastructures mentioned in an input list to generate an output list.

The software program 32 of the system 30 includes a correlation module 50 able to cross a map Cᵢₖ with at least one future position of the mobile terminal to determine a correlation coefficient.

The software program 32 of the system 30 includes a classification module 55 able to compute the value of a cost function.

The software program 32 of the system 30 includes a quality of experience module 60 making it possible to measure a property relative to the quality of experience associated with the use of the application Ak when it is executed by the mobile terminal, the latter being connected to an infrastructure Ii.

The software program 32 of the system 30 includes a module 65 for determining alternative trajectories.

The selection assistance method will now be described in detail in reference to FIG. 2.

In a prior phase 101, the database 31 is configured. To that end, the system 30 connects to a service terminal 16, in order to download various data.

In particular, during the configuration phase 101, the system 30 downloads a list L0 inventorying all of the infrastructures Ii available in the geographical zone in which the user of the mobile terminal 10 is called upon to move.

The system 30 downloads a plurality of maps. Based on the list L0 and the applications Aₖ installed on the mobile terminal 10, the corresponding maps Cₖᵢ are downloaded from the service terminal 16. Preferably, for a same application and a same infrastructure, several elementary maps Cₖᵢ(hⱼ) are downloaded, each of these maps corresponding to quality of experience information for a time range hⱼ.

The method 102 is next implemented during the execution by the mobile terminal 10 of the system 30.

In step 120, an estimate of a future position of the mobile terminal 10 is determined.

To that end, at the beginning of his movement, the user selects the trajectory tₙ that he will perform from the database 31.

For example, when he gets on the 8:50 bus on line 3 from the stop located in front of his home, the user selects, in the database 3, bus route no. 3 and selects, in the timetable for that line, the stop located in front of his home and the anticipated arrival time of the bus. To that end, during the configuration phase 101, the routes and timetables for the bus lines for the region within which the user of the mobile terminal 10 is called upon to travel have been downloaded into the database 31, from a website providing all of the routes for the bus lines in the region. From this information, the trajectory tₙ corresponding to the different future positions of the mobile terminal is determined in light of the selected route and the anticipated arrival times at each stop on that route.

A trajectory tₙ from the database 31 may also result from a learning step carried out during the configuration phase 101.

For example, in order for the trajectory from his home to his office to be stored in the database 31, the user makes that journey once while recording the successive current positions delivered by the localization module 20. At the end of this learning step, the successive current positions are associated with one another in a byte making up the trajectory tₙ, which is stored in the database. In a later usage phase, when the user will once again travel from his home to his office, he selects the trajectory tₙ previously learned, which is updated taking the current position delivered by the localization module 20 into account as the starting position.

The method 102 continues with a step 130 during which a first list L1 of the accessible infrastructures Ii is determined.

Executing the reducing module 45 makes it possible to identify the type of application Ak being executed by the mobile terminal 10. The reducing module 45 reads the corresponding maps Cₖᵢ in the database 31.

Based on the execution time range for the reducing module 45, the reducing module 45 reads the elementary maps Cₖᵢ(hⱼ) that correspond to this time range from among each map associated with the application Ak. The reducing module 45 eliminates the infrastructures from the list L0 for which there is no corresponding map in the database 31. A reduced list L1 is thus obtained.

Alternatively, the method according to the invention is implemented using, as parameter, the time range for which the user wishes to determine the best infrastructure to execute the application Aₖ. Consequently, the reducing module 45 takes into account the value of the time range parameter given to it.

In the following step 140, the reducing module 45 reduces the list L1 based on additional parameters, such as usage parameters of the mobile terminal 10. These parameters are defined during the initial configuration phase of the database 31.

In particular, some available infrastructures are only accessible to users with a specific subscription. If the user does not subscribe to that infrastructure, the corresponding infrastructure is removed from the list L1.

Thus, the list L1 of available infrastructures is constrained so as to obtain a list L2.

In step 150, the correlation module 50 weights each map Cₖᵢ associated with infrastructure Iᵢ from the list L2 with operating characteristics of the mobile terminal 10. These characteristics are for example downloaded from an application server during the configuration phase 101.

This may for example involve a gain of the transceiver module associated with the GSM protocol. Indeed, this gain varies from one mobile telephone model to another. This allows certain mobile telephones that have a high gain to be able to connect to an access point of a GSM infrastructure even on an antenna border, while other mobile telephones that have a lower gain can only connect to that access point if they are close to the antenna of the access point.

A weighted map Cₖᵢ* is thus obtained.

In step 160, the correlation module 50 computes a correlation coefficient between each weighted map Cᵢᵢ* associated with an infrastructure Iᵢ from the list L2 and the trajectory tₙ chosen in step 120. This coefficient is denoted Corr(Cₖᵢ; tₙ).

The correlation coefficient for example results from the integration, along the trajectory tₙ, of a function of the local quality of experience indicated on the weighted map Cₖᵢ*. In one elementary embodiment, the quality of experience function is the identity function.

In step 170, a classification module 55 computes a cost function for each infrastructure Iᵢ from the list L2.

The cost function includes a component making it possible to take into account the correlation coefficients computed in the preceding step for each infrastructure.

The cost function optionally includes other components associated with criteria predefined by the user. The user can thus for example predefine that one infrastructure should be favored relative to another infrastructure, based on the relative price of the communications on those two infrastructures. The corresponding component of the cost function will be low for the cost-effective infrastructure and high for the expensive infrastructure, so as to penalize the latter.

The list L2 is then sequenced based on the value of the cost function of each infrastructure. A ordered list L3 of accessible infrastructures is ultimately obtained.

In step 180, an infrastructure from the list L3 is selected.

In a first embodiment, the selection is done automatically by selecting the first infrastructure from the ordered list L3.

In a second embodiment, the ordered list L3 is displayed on a screen of the mobile terminal 10 and the user himself selects an infrastructure from that list.

The selection of a particular infrastructure leads to the implementation of the corresponding transceiver module. The latter is optionally configured with access data, such as a user profile, if for example information of the identifier type for the user subscribing to the selected infrastructure is required to establish a connection with the selected infrastructure. For example, the information from an eSIM card is used.

Then, as the mobile terminal 10 travels over the trajectory tₙ, the transceiver module Mᵢ adapted to the protocol of the selected infrastructure Iᵢ successively attaches itself to the different access points of the infrastructure Iᵢ.

Advantageously, in a step 190, during the first connection to the selected infrastructure Iᵢ, a table TPA including the identifiers of the access points of the selected infrastructure Iᵢ situated along the trajectory tₙ and, for each access point 14_i, its operating characteristics, is placed in the database 31. In this way, during the movement of the mobile terminal 10 along the trajectory tₙ, the passage from one cell to the other of the selected infrastructure Iᵢ will be done more quickly, the mobile terminal 10 knowing the access point 14_i in advance along which to establish a connection and the operating characteristics of the access point.

The method includes a phase 103 for updating the maps Cₖᵢ.

During the movement of the mobile terminal 10, instantaneous properties relative to the quality of experience associated with the execution of the application Aₖ, while the mobile terminal 10 is connected to the selected infrastructure Iᵢ, are computed in real time by the quality of experience module 60 of the system 30.

A “log” file, Logₖᵢ, is created in the database 31 and gradually enriched.

During the use of the mobile terminal, several log files are created for different applications and/or different infrastructures.

During the following connection of the system 30 to the service terminal 16, for example during a new configuration phase of the database 31, the log files Logₖᵢ accumulated on the mobile terminal 10 are transferred onto the service terminal 16. They are processed there to enrich and update the corresponding maps Cₖᵢ. The maps aggregate the log files for different users.

Advantageously, the date on which a property relative to the quality of experience was measured makes it possible to establish elementary maps by time range hⱼ.

In the preceding description, the implementation of the method is done at the starting point for the trajectory tₙ before the user, and consequently the portable terminal he is transporting, commands traveling along the selected journey. Alternatively, the method is implemented in any of the intermediate positions along the trajectory tₙ. From the instantaneous position of the mobile terminal 10, given by the localization means 20, the system determines the intermediate point of the trajectory near which the mobile terminal 10 is located. The method is then iterated between the intermediate position and the arrival position.

Advantageously, the mobile terminal 10 is provided with a module 65 for determining alternative trajectories. When this module is executed, it makes it possible to build alternative trajectories tₙ* around the trajectory tₙ selected by the user. Each alternative trajectory is subject to the calculation of a correlation coefficient with the adapted maps Cₖᵢ. An alternative trajectory constitutes a spatial and/or temporal variation around the basic trajectory.

If, along a trajectory, a first infrastructure leads to a high correlation coefficient, along an alternative trajectory, it may be a second infrastructure, different from the first, that leads to a high correlation coefficient.

The object to be selected is then no longer an infrastructure relative to a given trajectory, but a pair made up of an infrastructure and an alternative trajectory relative to a given trajectory. At the end of implementation of the method, the user is invited to select the most appropriate infrastructure/alternative trajectory pair in terms of quality of experience, in light of the trajectory tₙ initially considered.

FIG. 3 diagrammatically shows an example use of this method to assist in selecting an infrastructure.

A user is considering traveling between the bus station A near his hotel H, in the downtown area of a town, and the airport B, on the periphery of the city. He wishes to obtain a departure time from point A to arrive at point B by an arrival time (constrained by his flight time).

Bus lines no. 1 and no. 2 have routes making it possible to perform this journey.

If the user chooses line no. 1, the corresponding trajectory t1 is loaded in the memory of the terminal 10.

Then, the implementation of the method makes it possible to obtain an ordered list of infrastructures accessible along the trajectory t1. This list is developed from the correlation between the trajectory t1 and the maps associated with the application that the user will choose to execute during his journey, accessible infrastructures, and optionally the time range of the day. This list is also developed taking into account the user's profile: preferred infrastructure, infrastructure to which the user subscribes, etc.

The user chooses one of these infrastructures from the ordered list of accessible infrastructures. In order to execute the application Aₖ, the mobile terminal connects to the selected infrastructure, while the user begins to travel along the trajectory t1.

If the module 65 is active on the mobile terminal 10, while the user initially chooses the trajectory t1 to go from A to B, the module 65 looks for alternative trajectories. Thus, among the different bus lines making it possible to reach the apart from the hotel, the terminal 10 identifies the trajectory t2. At the same time as the calculations for the trajectory t1, similar calculations are done for the trajectory t2.

The user is lastly invited to select an infrastructure/trajectory pair. Thus, although he was initially considering using bus line no. 1, the user takes bus line no. 2, so as to follow a trajectory t2 having a higher anticipated quality of experience value than that associated with trajectory t1.

In still another alternative, the mobile terminal determines the ordered list of infrastructures suitable for the type of application Aₖ, irrespective of whether this application is executed at the current moment. Then, during the execution of a particular application, the user is invited to consult the ordered list of available infrastructures associated with this application and to select the best infrastructure.

Alternatively, the selected trajectory is subdivided into elementary trajectories, for each of which the mobile terminal 10 determines the best infrastructure. Thus, in the example of FIG. 3, the user leaves his hotel H on foot, walking to the bus station A. He wishes to be able to receive telephone calls. He therefore chooses to connect to a GSM infrastructure. He then must take a bus to reach the airport, knowing that during this journey, he would like to watch a newscast in the form of a video stream. A Wi-Fi infrastructure is best suited to transferring this data. Then, among the different bus lines making it possible to go to the airport, he chooses the trajectory t2 allowing him to stay within range of free access points of the infrastructure managed by his usual operator. Upon arriving at the airport, while waiting for his flight, the user wishes to check his e-mail. He connects using a 3G infrastructure to send and receive e-mails.

The log file includes, at each moment, a measurement of a property corresponding to the quality of experience perceived by the user during the execution of the application Aₖ, the mobile terminal being connected to the infrastructure Optionally, if several applications are executed simultaneously or certain properties relative to the quality of experience may be determined without the corresponding application being executed, or at least executed as a background task, different log files are enriched at the same time.

1-14. (canceled)

15. A system, for a mobile terminal, for assisting in selecting a radio communication infrastructure from among a plurality of available radio communication infrastructures, in order to establish a communication link between the mobile terminal and a selected radio communication infrastructure allowing an application executed on the mobile terminal to access a remote resource, the system, implemented on the mobile terminal, including:
a database including a plurality of maps, each map being associated with a radio communication infrastructure from said plurality of available radio communication infrastructures and an application type, a map giving, at each point of a geographical zone, a local value of a property relative to a quality of experience associated with an execution of an application of said application type accessing a remote resource through said infrastructure; and a plurality of trajectories that may be followed by the mobile terminal through said geographical zone;
a selection means allowing a user of the terminal to choose a trajectory from among the plurality of trajectories stored in the database;
a localization means generating a current position of the mobile terminal;
a correlation means determining, from the current position and the trajectory chosen, and for each map associated with the application type corresponding to the application executed on the mobile terminal, a correlation coefficient; and
a selection means selecting, based on the correlation coefficients determined, to select a radio communication infrastructure from among said plurality of radio communication infrastructures.

16. The system according to claim 15, wherein the selection means includes a classification means computing a cost function from the correlation coefficients determined and usage parameters of the mobile terminal, the value of the cost function computed for each radio communication infrastructure making it possible to obtain a ordered list of the available radio communication infrastructures, the selection means using said ordered list to select a radio communication infrastructure.

17. The system according to claim 15, including a module measuring a quality of experience associated with an execution of an application accessing a remote resource while the mobile terminal is connected to the radio communication infrastructure selected, the measures being stored in a log file of the mobile terminal.

18. The system according to claim 15, wherein each map of the database includes a plurality of elementary maps, each elementary map being associated with a specific time range, the correlation means choosing, for each map, an elementary map from among the elementary maps of said map based on the time range of the elementary maps and the current position and the trajectory selected, the correlation coefficient of the radio communication infrastructure being determined by using the elementary map chosen.

19. The system according to claim 15, wherein a position associates a geographical point, defined by three spatial coordinates, and an instant, defined by a time coordinate, and a trajectory is a set of successive positions.

20. The system according to claim 15, wherein the selection means updates the trajectory selected in the database, using the current position delivered by the localization means as the position on the trajectory.

21. The system according to claim 15, wherein the correlation module weights each map associated with a radio communication infrastructure with operating characteristics of the mobile terminal.

22. The system according to claim 15, wherein the correlation coefficient computed by the correlating means results from the integration, along the selected trajectory, of a function of the local quality of experience indicated on the map considered.

23. An assembly made up of a server terminal and a plurality of systems to assist in selecting a radio communication infrastructure, each system being a system according to claim 15, each system being implemented by a mobile terminal, wherein the server terminal includes a plurality of maps, each map being associated with a radio communication infrastructure from a plurality of radio communication infrastructures available in a geographical zone and an application type, a map giving, at each point of said geographical zone, a local value of a property relative to a quality of experience associated with an execution of an application of said application type accessing a remote resource while the mobile terminal on which the application is executed is connected to said radio communication infrastructure.

24. The assembly according to claim 23, wherein each map includes a plurality of elementary maps, each elementary map being associated with a time range.

25. A method, for a mobile terminal, for assisting in the selection of a radio communication infrastructure from among a plurality of radio communication infrastructures available, in order to establish a communication link between the mobile terminal and the radio communication infrastructure selected to allow an application executed on the mobile terminal to access a remote resource, the method including the following steps:
providing a plurality of maps, each map being associated with a radio communication infrastructure from said plurality of radio communication infrastructures and giving, at each point of a geographical zone, a local value of a property relative to a quality of experience associated with an execution of said application accessing said remote resource through said radio communication infrastructure;
providing a plurality of trajectories that may be followed by said mobile terminal through said geographical zone;
selecting a trajectory;
localizing the mobile terminal at the current instant so as to generate a current position of the mobile terminal;
computing, from said current position and the trajectory selected, and for each map associated with the application type corresponding to the application executed on the mobile terminal, a correlation coefficient; and
selecting, based on the computed correlation coefficients, a radio communication infrastructure from among said plurality of radio communication infrastructures.

26. The method according to claim 25, wherein, each map of the database including a plurality of elementary maps, each elementary map being associated with a specific time range, the step for computing a correlation coefficient first consists of choosing, for each map, an elementary map from among the elementary maps of said map based on the time range of the elementary maps and the current position and the or each future position, then computing the correlation coefficient of said radio communication infrastructure by using the elementary map chosen.

27. The method according to claim 25, including a step for computing a cost function from the correlation coefficients and usage parameters of the mobile terminal, the value of the cost function computed for each radio communication infrastructure making it possible to obtain an ordered list of the radio communication infrastructures available, the selection step using said ordered list to select a radio communication infrastructure.

28. The method according to claim 25, including a step for creating a log file, during which a property is measured and stored in real-time relative to a quality of experience associated with the execution of an application accessing a remote resource for the mobile terminal is connected to the radio communication infrastructure selected, said log file being able to be downloaded on a remote terminal and used to update the corresponding map, a mobile terminal regularly connecting to said remote terminal in order to download updated maps from its database.
